(19) United States
(12) Patent Application Publication
(10) Pub. No.: US 2020/0254558 A1
(43) Pub. Date: Aug. 13, 2020

(54) LASER PROCESSING APPARATUS, CONTROL METHOD OF LASER PROCESSING APPARATUS, AND CONTROL PROGRAM OF LASER PROCESSING APPARATUS

(71) Applicant: KANTATSU CO., LTD., Yaita-shi (JP)

(72) Inventor: Eiji OSHIMA, Yaita-shi (JP)

(21) Appl. No.: 16/665,442

(22) Filed: Oct. 28, 2019

(30) Foreign Application Priority Data
Oct. 26, 2018 (JP) 2018-201378

(51) Int. Cl. B23K 26/03; B23K 26/04

(52) U.S. Cl. CPC B23K 26/032; B23K 26/048

(57) ABSTRACT

Accurate processing is performed. A laser processing apparatus includes a light irradiator that irradiates a processing target object with a laser beam based on a processing model, a measurer that measures a distance from the light irradiator to the processing target object based on reflected light of the laser beam from the processing target object, and a processing controller that performs processing control based on the measured distance.

### BACKGROUND OF THE INVENTION

### Field of the Invention

The present invention relates to a laser processing apparatus, a control method of the laser processing apparatus, and a control program of the laser processing apparatus.

### Description of the Related Art

In the above technical field, patent literature 1 discloses a technique of receiving reflected light of exposure light by a CCD camera and adjusting a focus position.
[Patent Literature 1] Japanese Patent Laid-Open No. 2006-240045

### SUMMARY OF THE INVENTION

In the technique described in the above literature, however, it is impossible to perform accurate processing.

The present invention provides a technique of solving the above-described problem.

One example aspect of the present invention provides a laser processing apparatus comprising:

a light irradiator that irradiates a processing target object with a laser beam based on a processing model;

a measurer that measures a distance from the light irradiator to the processing target object based on reflected light of the laser beam from the processing target object; and

a processing controller that performs processing control based on the measured distance.

Another example aspect of the present invention provides a control method of a laser processing apparatus, comprising:

irradiating a processing target object with a laser beam based on a processing model;

measuring a distance from a light irradiator to the processing target object based on reflected light of the laser beam from the processing target object; and

performing processing control based on the measured distance.

Still other example aspect of the present invention provides a control program of a laser processing apparatus for causing a computer to execute a method, comprising:

irradiating a processing target object with a laser beam based on a processing model;

measuring a distance from a light irradiator to the processing target object based on reflected light of the laser beam from the processing target object; and

performing processing control based on the measured distance.

According to the present invention, since a distance is measured based on reflected light of a laser beam, it is possible to perform accurate processing.

### BRIEF DESCRIPTION OF THE DRAWINGS

FIG. 1 is a view showing the arrangement of a laser processing apparatus according to the first example embodiment of the present invention;

FIG. 2 is a view for explaining the arrangement of a laser processing apparatus according to the second example embodiment of the present invention;

FIG. 3 is a view for explaining the arrangement of a light irradiator of the laser processing apparatus according to the second example embodiment of the present invention;

FIG. 4 is a table for explaining an example of a processing table provided in the laser processing apparatus according to the second example embodiment of the present invention;

FIG. 5 is a block diagram for explaining the hardware arrangement of the laser processing apparatus according to the second example embodiment of the present invention;

FIG. 6A is a flowchart for explaining an operation procedure of the laser processing apparatus according to the second example embodiment of the present invention;

FIG. 6B is a flowchart for explaining another operation procedure of the laser processing apparatus according to the second example embodiment of the present invention;

FIG. 7 is a view for explaining the arrangement of a laser processing apparatus according to the third example embodiment of the present invention;

FIG. 8 is a table for explaining an example of a notification table provided in the laser processing apparatus according to the third example embodiment of the present invention;

FIG. 9 is a block diagram for explaining the hardware arrangement of the laser processing apparatus according to the third example embodiment of the present invention; and

FIG. 10 is a flowchart for explaining the operation procedure of the laser processing apparatus according to the third example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

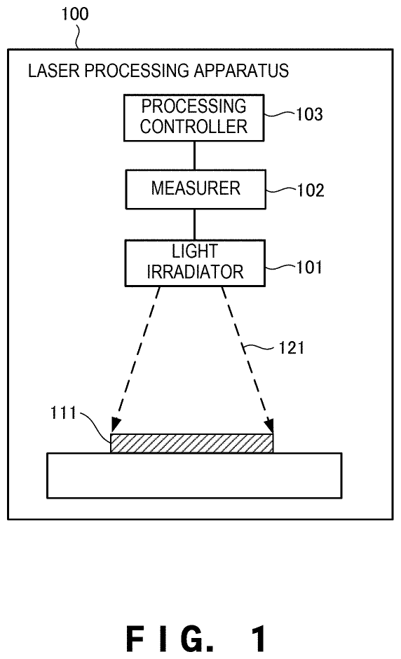

A laser processing apparatus 100 according to the first example embodiment of the present invention will be described with reference to FIG. 1. The laser processing apparatus 100 is an apparatus that processes a processing target object or the like using a laser beam. As shown in FIG. 1, the laser processing apparatus 100 includes a light irradiator 101, a measurer 102, and a processing controller 103.

The light irradiator 101 irradiates a processing target object 111 with a laser beam 121 based on a processing model. The measurer 102 measures a distance from the light irradiator 101 to the processing target object 111 based on reflected light of the laser beam 121 from the processing target object 111. The processing controller 103 performs processing control based on the measured distance.

According to this example embodiment, since the distance is measured based on the reflected light of the laser beam, it is possible to perform accurate processing.

### Second Example Embodiment

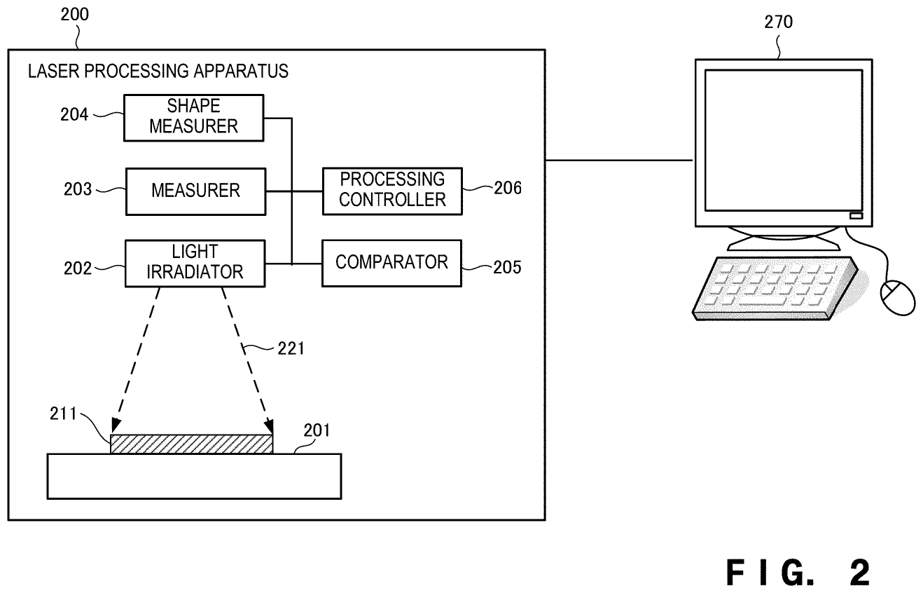

A laser processing apparatus according to the second example embodiment of the present invention will be described next with reference to FIGS. 2 to 5. FIG. 2 is a view for explaining the arrangement of a laser processing apparatus according to this example embodiment. A laser processing apparatus 200 includes a processing stage 201, a light irradiator 202, a measurer 203, a shape measurer 204, a comparator 205, and a processing controller 206. The processing stage 201 is a place where a processing target object 211 is processed. That is, the processing target object 211 is processed on the processing stage 201.

The light irradiator 202 irradiates the processing target object 211 with a laser beam 221. The laser beam 221 includes an infrared laser beam and a visible laser beam but is not limited to them. The laser beam 221 may include, for example, a solid-state laser beam and a gas laser beam. Furthermore, the laser beam 221 may include an ultraviolet laser beam and a blue laser beam.

The light irradiator 202 performs irradiation by switching the laser beam 221 in accordance with the application purpose or aim. When processing the processing target object 211, the light irradiator 202 performs irradiation by switching to the laser beam 221 for processing. When the user wants to know the state of the processing target object 211, the light irradiator 202 performs irradiation by switching to the visible light laser beam 221. Furthermore, when the user wants to know (measure) the distance from the processing target object 211, the light irradiator 202 performs irradiation by switching to the infrared (IR) laser beam 221. Note that the laser beam 221 used when the user wants to know the distance is not limited to the infrared laser beam 221.

The measurer 203 measures the distance from the processing target object based on reflected light of the laser beam 221 from the processing target object 211. The measurer 203 measures the distance, for example, during processing of the processing target object 211 or after the end of the processing of the processing target object 211.

The measurer 203 includes a light receiver that receives the reflected light of the laser beam 221 from the processing target object 211. The light receiver is, for example, a light receiving element (light receiving sensor) that can receive infrared light. Examples of the light receiving element are a CCD (Charged Coupled Devices) sensor and a CMOS (Complementary Metal-Oxide-Semiconductor) sensor but are not limited to them. Measurement of the distance by the measurer 203 is implemented by, for example, the TOF (Time of Flight) method, the trigonometry method, the phase difference method (phase shift method), or the like. Measurement of the distance can appropriately be selected in accordance with the feature of each method.

The shape measurer 204 measures the shape of the processing target object 211 based on the measured distances. The shape measurer 204 receives light receiving data received by the measurer 203. Since the light receiving data received by the shape measurer 204 includes data indicating a specific position from which the reflected light comes, the shape measurer 204 measures the shape of the processing target object 211 using the position information and the distance measured by the measurer 203. That is, the shape measurer 204 operates as a scanner that can read the three-dimensional shape of the processing target object 211 or the like.

Note that if processing by the laser processing apparatus 200 is laminating and shaping, the shape of the processing target object 211 may be measured per layer, per a plurality of layers, or after the end of processing of the processing target object 211. For example, if the shape is measured per layer or per a plurality of layers, processing or shaping can be performed by making a modification every time while processing or shaping the processing target object 211, thereby making it possible to perform accurate processing or shaping. By performing processing or shaping while measuring the shape in this way, a processed product or shaped object of high quality is obtained. The yield of the obtained processed product or shaped object is also improved.

The comparator 205 compares, with a processing model (shaping model), the shape of the processing target object 211 measured by the shape measurer 204.

The processing controller 206 performs processing control in accordance with a comparison result obtained by the comparator 205. After completion of processing of the processing target object 211, the shape of the processing target object 211 is measured, and the comparator 205 performs comparison. As a result, if the shape of the processing target object 211 does not match the shape of the processing model, for example, the processing controller 206 performs additional processing of the mismatched portion.

The shape of the processing target object 211 is measured during processing of the processing target object 211, and the comparator 205 performs comparison. As a result, if the shape of the processing target object 211 does not match the shape of the processing model, for example, the processing controller 206 performs additional processing of the mismatched portion, and then performs the remaining processing. The additional processing includes, for example, processing of cutting an unnecessary portion and processing of adding a missing portion but is not limited to them. Instead of the additional processing, the laser processing apparatus 200 modifies the mismatched portion by changing a processing program or the irradiation condition of the laser beam.

The operator of the laser processing apparatus 200 operates the laser processing apparatus 200 using an operation computer 270. The operator transmits processing data (shaping data) created by the CAD (Computer Aided Design) of the operation computer 270 to the laser processing apparatus 200 to be used for processing or shaping. Note that the CAD may be installed in a computer different from the operation computer 270.

Upon receiving the processing data from the operation computer 270, the laser processing apparatus 200 controls irradiation with the laser beam 221 based on the received processing data. Note that creation of the processing data or shaping data is not limited to creation using the CAD, and may be, for example, creation using CAE (Computer Aided Engineering), an application of a smartphone, or the like.

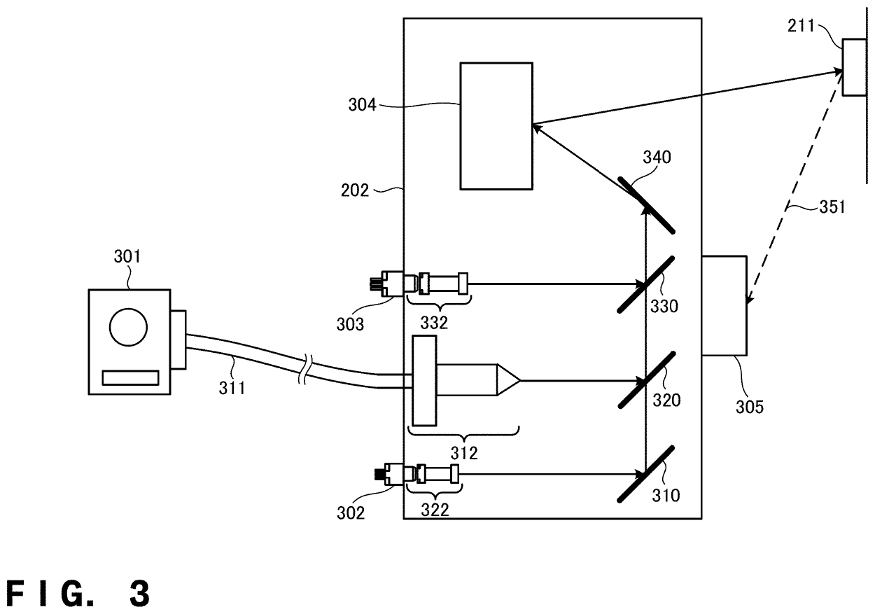

FIG. 3 is a view for explaining the arrangement of the light irradiator of the laser processing apparatus according to this example embodiment. The light irradiator 202 includes a light source 301, laser sources 302 and 303, a two-dimensional MEMS (Micro Electro Mechanical System) mirror 304, and a light receiver 305. The two-dimensional MEMS mirror 304 is an electromechanical mirror.

The light source 301 serves as an oscillator of a solid-state laser, a gas laser, or a semiconductor laser. A laser beam emitted from the light source 301 is guided to a condenser 312 through an optical fiber 311 that guides light. The condenser 312 includes a condenser lens and a collimator lens.

The laser source 302 is a light source of an infrared laser beam. The laser source 303 is a light source of a high-power laser beam. Laser beams emitted from the laser sources 302 and 303 are guided to condensers 322 and 332, respectively. Each of the condensers 322 and 332 includes a condenser lens and a collimator lens. Each of the laser sources 302 and 303 is a semiconductor LD (Laser Diode), and is a laser beam oscillation element that emits (oscillates) a laser beam of each wavelength or the like.

The two-dimensional MEMS mirror 304 is an electromechanical mirror. The two-dimensional MEMS mirror 304 is a driving mirror that is driven based on a control signal input from the outside, and vibrates to reflect the laser beam while changing the angle in the horizontal direction (X direction) and the vertical direction (Y direction). The laser beam reflected by the two-dimensional MEMS mirror 304 is corrected by a view angle correction element (not shown) in terms of a view angle. Then, the laser beam which has been corrected in terms of the view angle is scanned on the processing target object 211 or a process surface, thereby performing desired processing or shaping. Note that the view angle correction element is installed, as needed. Note that two one-dimensional MEMS mirrors may be used, instead of using the two-dimensional MEMS mirror 304.

The laser beam emitted from the light source 301 is reflected by mirrors 320 and 340 to reach the two-dimensional MEMS mirror 304. Similarly, the laser beam emitted from the laser source 302 is reflected by a mirror 310 and the mirror 340 to reach the two-dimensional MEMS mirror 304. The laser beam emitted from the laser source 303 is reflected by a mirror 330 and the mirror 340 to reach the two-dimensional MEMS mirror 304. The mirror 340 is arranged in a bottom portion (bottom surface) of the light irradiator 202. The mirror 310 reflects the reflected light of the laser beam from the laser source 302 downward to the mirror 340 arranged on the bottom surface. The mirror 320 reflects the reflected light of the laser beam from the light source 301 downward to the mirror 340 arranged on the bottom surface. Similarly, the mirror 330 reflects the reflected light of the laser beam from the laser source 303 downward to the mirror 340 arranged on the bottom surface. The mirror 340 reflects each of the laser beams from the mirrors 310, 320, and 330 upward to the two-dimensional MEMS mirror 304 arranged above the mirror 340. The two-dimensional MEMS mirror 304 scans the reflected light from the mirror 340 in the two-dimensional directions to perform irradiation.

Each of the laser beams emitted from the light source 301 and the laser sources 302 and 303 is reflected by the mirror 310, 320, or 330, and passes through the same optical path (one optical path), thereby reaching the processing target object 211.

The light receiver 305 is a light receiving element that receives reflected light 351 from the processing target object 211. When a sensor that detects that the laser beam exits from the two-dimensional MEMS mirror 304 is provided in the two-dimensional MEMS mirror 304 or its periphery, the time from when the laser beam exits from the two-dimensional MEMS mirror 304 until the laser beam reaches the light receiver 305 as the reflected light 351 can be measured. This can measure the distance by, for example, the TOF method.

The light receiver 305 is a photodetector (PD) but may be a CCD (Charge Coupled Device), a CMOS (Complementary Metal Oxide Semiconductor) sensor, or the like. Note that the example in which the light receiver 305 is installed in the light irradiator 202 has been described with reference to FIG. 3. However, the light receiver 305 may be installed at any position as long as it can receive the reflected light 351.

Since the laser processing apparatus 200 is provided with the light receiver 305, it can perform on-machine measurement during processing or after processing. Therefore, for example, measurement during processing enables the laser processing apparatus 200 to process the processing target object 211 while changing and modifying the processing condition and the like every time.

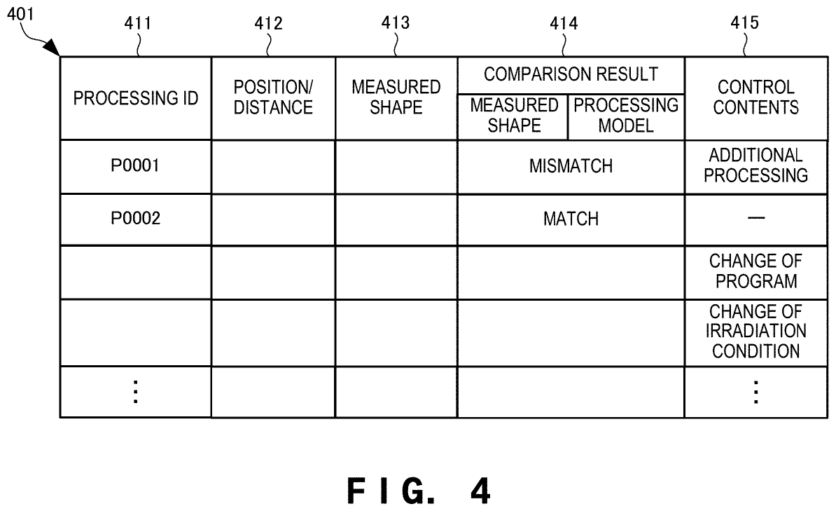

FIG. 4 is a table for explaining an example of a processing table provided in the laser processing apparatus according to this example embodiment. A processing table 401 stores a position/distance 412, a measured shape 413, a comparison result 414, and control contents 415 in association with a processing ID (IDentifier) 411. The processing ID 411 is an identifier for identifying processing. The position/distance 412 indicates a distance from each point (position) on the surface of the processing target object 211. The measured shape 413 is the measured shape of the processing target object 211. The comparison result 414 indicates a result of comparing the measured shape of the processing target object 211 with the shape of the processing model. The control contents 415 indicate contents of processing control performed based on a comparison result. Then, the laser processing apparatus 200 executes processing control with reference to, for example, the processing table 401.

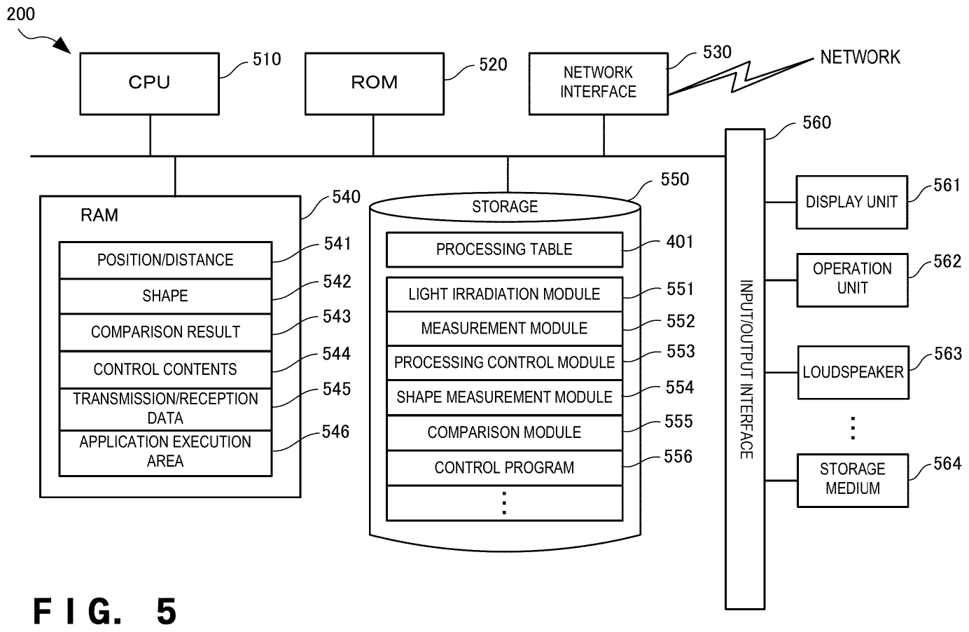

FIG. 5 is a block diagram showing the hardware arrangement of the laser processing apparatus according to this example embodiment. A CPU (Central Processing Unit) 510 is an arithmetic control processor, and implements the functional components of the laser processing apparatus 200 shown in FIG. 2 by executing a program. The CPU 510 may include a plurality of processors to parallelly execute different programs, modules, tasks, or threads. A ROM (Read Only Memory) 520 stores permanent data such as initial data and a program, and other programs. A network interface 530 communicates with another apparatus via a network. Note that the number of CPUs 510 is not limited to one, and a plurality of CPUs or a GPU (Graphics Processing Unit) for image processing may be included. The network interface 530 desirably includes a CPU independent of the CPU 510, and writes or reads out transmission/reception data in or from the area of a RAM (Random Access Memory) 540. It is desirable to provide a DMAC (Direct Memory Access Controller) (not shown) for transferring data between the RAM 540 and a storage 550. Furthermore, the CPU 510 processes the data by recognizing that the data has been received by or transferred to the RAM 540. The CPU 510 prepares a processing result in the RAM 540, and delegates succeeding transmission or transfer to the network interface 530 or DMAC.

The RAM 540 is a random access memory used as a temporary storage work area by the CPU 510. An area to store data necessary for implementation of this example embodiment is allocated to the RAM 540. A position/distance 541 indicates a distance from the processing target object 211. A shape 542 indicates the measured shape of the processing target object 211. A comparison result 543 indicates a result of comparing the measured shape of the processing target object 211 with the shape of the processing model. Control contents 544 indicate contents of processing control according to a comparison result. These data are deployed from, for example, the processing table 401.

Transmission/reception data 545 is data transmitted/received via the network interface 530. The RAM 540 includes an application execution area 546 for executing various application modules.

The storage 550 stores a database, various parameters, or the following data or programs necessary for implementation of this example embodiment. The storage 550 stores the processing table 401. The processing table 401 is the table, shown in FIG. 4, for managing the relationship between the processing ID 411 and the control contents 415 and the like.

The storage 550 also stores a light irradiation module 551, a measurement module 552, a processing control module 553, a shape measurement module 554, and a comparison module 555. The light irradiation module 551 is a module that irradiates the processing target object 211 with the laser beam. The measurement module 552 is a module that measures the distance from the processing target object 211 based on the reflected light 351 from the processing target object 211. The processing control module 553 is a module that controls processing based on the measured distance and the comparison result. The shape measurement module 554 is a module that measures the shape of the processing target object 211 based on the measured distance. The comparison module 555 is a module that compares the measured shape of the processing target object 211 with the shape of the processing model. These modules 551 to 555 are read out by the CPU 510 into the application execution area 546 of the RAM 540, and executed. A control program 556 is a program for controlling the whole laser processing apparatus 200.

An input/output interface 560 interfaces input/output data with an input/output device. The input/output interface 560 is connected to a display unit 561 and an operation unit 562. In addition, a storage medium 564 may be connected to the input/output interface 560. A loudspeaker 563 serving as a voice output unit, a microphone (not shown) serving as a voice input unit, or a GPS position determiner may also be connected. Note that programs and data which are associated with the general-purpose functions of the laser processing apparatus 200 and other feasible functions are not shown in the RAM 540 or the storage 550 of FIG. 5.

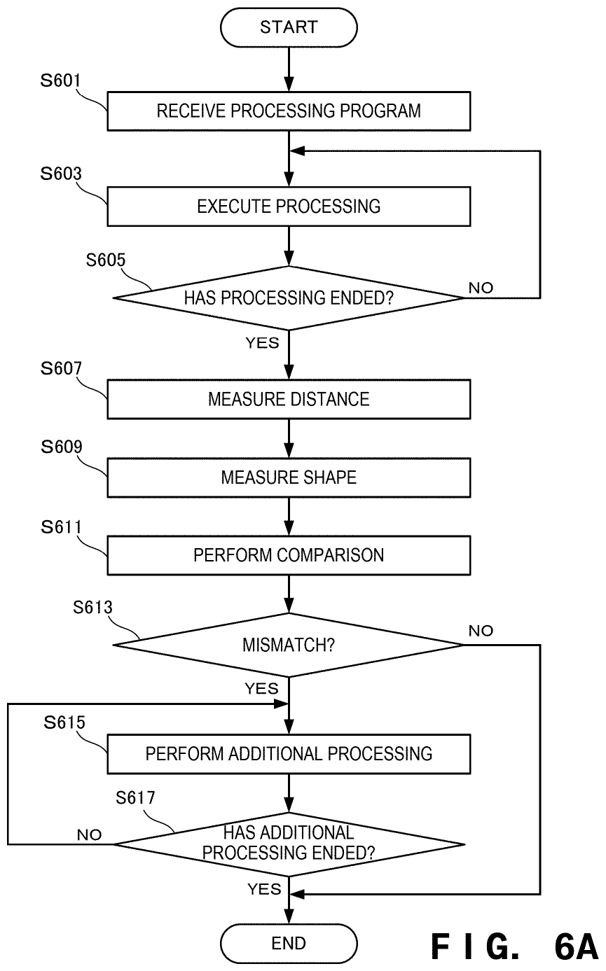

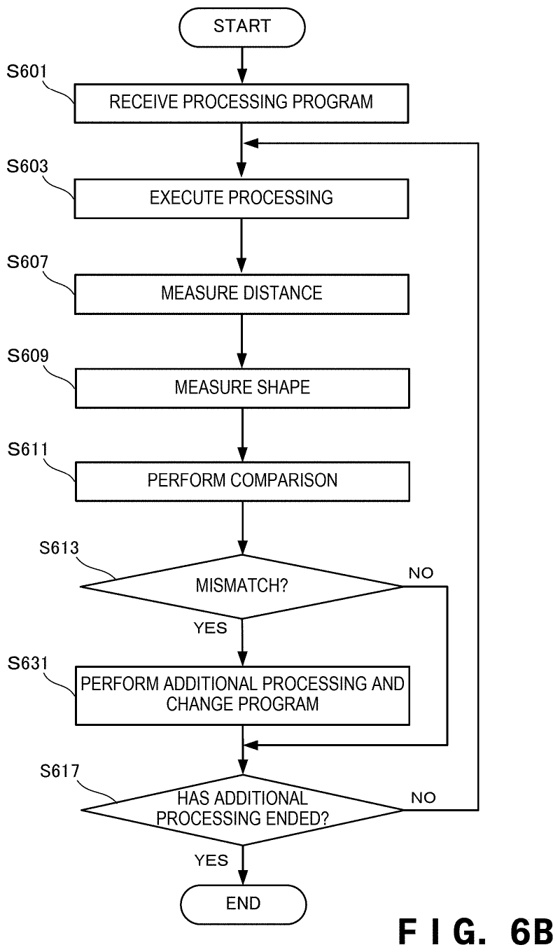

FIG. 6A is a flowchart for explaining a processing procedure of the laser processing apparatus according to this example embodiment. This flowchart is executed by the CPU 510 of FIG. 5 using the RAM 540, thereby implementing the functional components of the laser processing apparatus 200 shown in FIG. 2. Note that the flowchart shown in FIG. 6A is a flowchart when the distance and shape are measured after the end of processing of the processing target object 211.

In step S601, the laser processing apparatus 200 receives the processing program. In step S603, the laser processing apparatus 200 executes processing of the processing target object 211 based on the received processing program. In step S605, the laser processing apparatus 200 determines whether the processing of the processing target object 211 has ended. If the processing has not ended (NO in step S605), the laser processing apparatus 200 returns to step S603 to continue the processing; otherwise (YES in step S605), the laser processing apparatus 200 advances to the next step.

In step S607, the laser processing apparatus 200 measures the distance from the processing target object 211 based on the reflected light 351. In step S609, the laser processing apparatus 200 measures the shape of the processing target object 211 based on the measured distance. In step S611, the laser processing apparatus 200 compares the measured shape of the processing target object 211 with the shape of the processing model. In step S613, the laser processing apparatus 200 determines whether a comparison result indicates a mismatch. If the comparison result indicates no mismatch (NO in step S613), that is, the measured shape of the processing target object 211 matches the shape of the processing model, the laser processing apparatus 200 ends the process.

If the comparison result indicates a mismatch (YES in step S613), that is, the measured shape of the processing target object 211 does not match the shape of the processing model, the laser processing apparatus 200 advances to step S615. In step S615, the laser processing apparatus 200 performs additional processing to modify the mismatched portion. In step S617, the laser processing apparatus 200 determines whether the additional processing has ended. If the additional processing has not ended (NO in step S617), the laser processing apparatus 200 returns to step S615 to continue the additional processing; otherwise (YES in step S617), the laser processing apparatus 200 ends the process.

FIG. 6B is a flowchart for explaining another operation procedure of the laser processing apparatus according to this example embodiment. Note that the flowchart shown in FIG. 6B is a flowchart when the distance and shape are measured during processing of the processing target object 211. The same step numbers as in FIG. 6A denote the same steps and a description thereof will be omitted. In step S631, the laser processing apparatus 200 modifies the mismatched portion by performing additional processing and changing a shaping program.

According to this example embodiment, it is possible to perform accurate processing. In addition, since the distance from the process surface and the shape of the processing target object are measured, the irradiation condition of the laser beam can be changed during processing, thereby performing more accurate processing. Furthermore, since the light receiver is provided, it is possible to perform on-machine measurement during processing, thereby confirming the processing state of the processing target object or the shaping state of the shaped object. Since on-machine measurement can be performed, it is possible to perform processing or shaping while making a modification every time.

### Third Example Embodiment

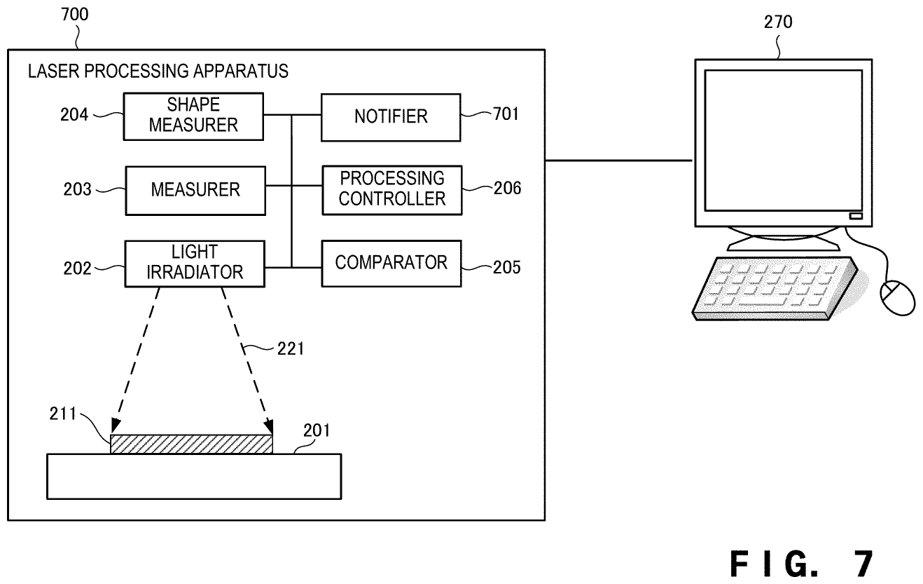

A laser processing apparatus according to the third example embodiment of the present invention will be described next with reference to FIGS. 7 to 10. FIG. 7 is a view for explaining the arrangement of the laser processing apparatus according to this example embodiment. The laser processing apparatus according to this example embodiment is different from that in the above-described second example embodiment in that a notifier is provided. The remaining components and operations are the same as those in the second example embodiment. Hence, the same reference numerals denote the same components and operations, and a detailed description thereof will be omitted.

A laser processing apparatus 700 includes a notifier 701. The notifier 701 makes a notification of a comparison result obtained by a comparator 205. If, for example, the measured shape of a processing target object 211 does not match the shape of a model, the notifier 701 notifies the operator of the laser processing apparatus 700 or the like of the comparison result as a processing error.

The notification processing by the notifier 701 is performed by, for example, displaying an error message on a display device such as a monitor attached to the laser processing apparatus 700. Alternatively, the notification processing by the notifier 701 is performed by flickering a lamp attached to the laser processing apparatus 700 or outputting a notification sound from a loudspeaker or the like. Furthermore, the notifier 701 notifies the operator of the laser processing apparatus 700 of the occurrence of the error by transmitting an error message to a mobile device such as a smartphone held by the operator.

When the notifier 701 makes a notification of the error in this way, the operator or the like can abort the processing by the laser processing apparatus 700. When a predetermined time elapses after the notifier 701 makes a notification of the error, even if the operator issues no processing abortion instruction, the laser processing apparatus 700 may abort the processing.

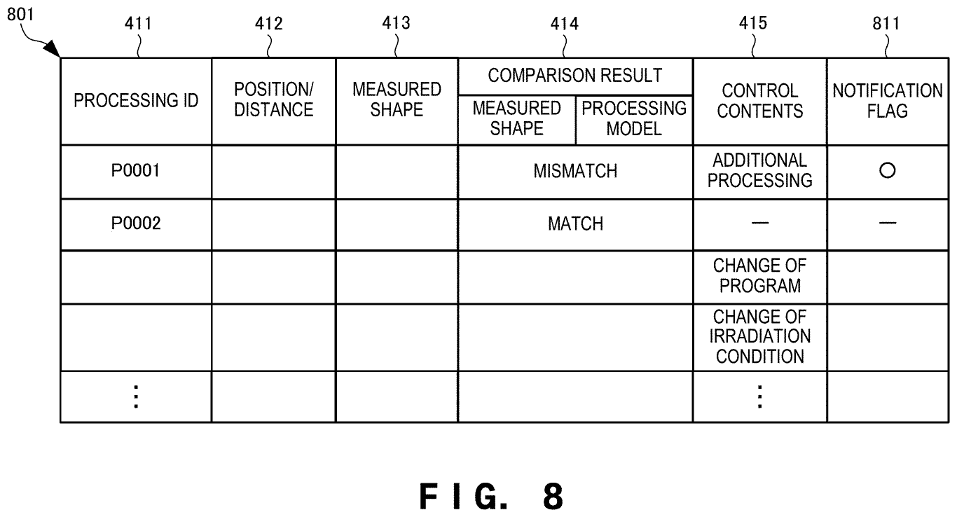

FIG. 8 is a table for explaining an example of a notification table provided in the laser processing apparatus according to this example embodiment. A notification table 801 stores a notification flag 811 in association with a processing ID 411. The notification flag 811 is a flag that is turned on when a comparison result indicates a mismatch. If the notification flag 811 is turned on, the laser processing apparatus 700 makes a notification of the comparison result of the mismatch as an error.

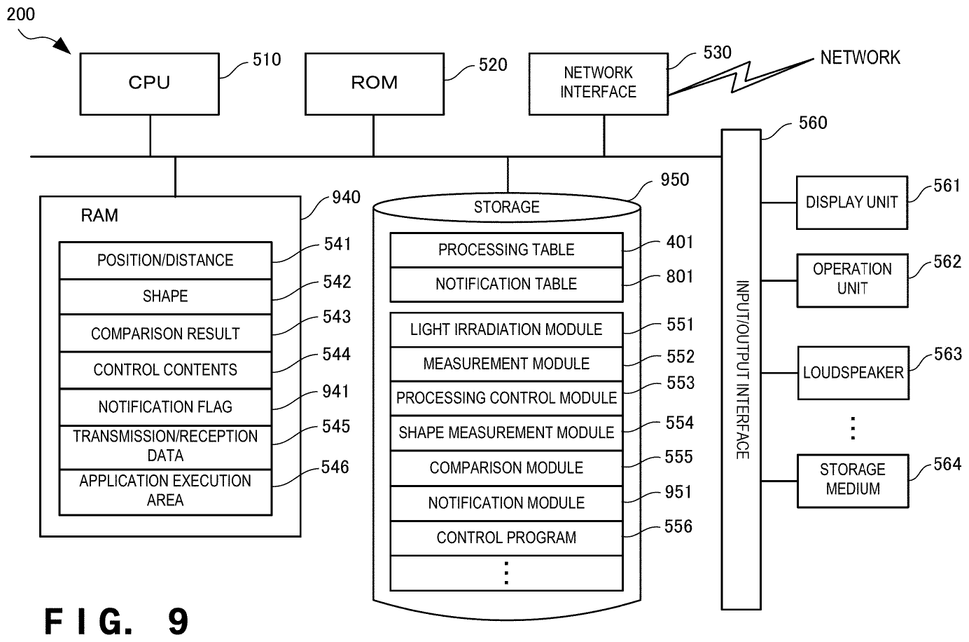

FIG. 9 is a block diagram for explaining the hardware arrangement of the laser processing apparatus according to this example embodiment. A RAM 940 is a random access memory used as a temporary storage work area by a CPU 510. An area to store data necessary for implementation of this example embodiment is allocated to the RAM 940. A notification flag 941 indicates a flag that is turned on when a comparison result indicates a mismatch. This data is deployed from, for example, the notification table 801.

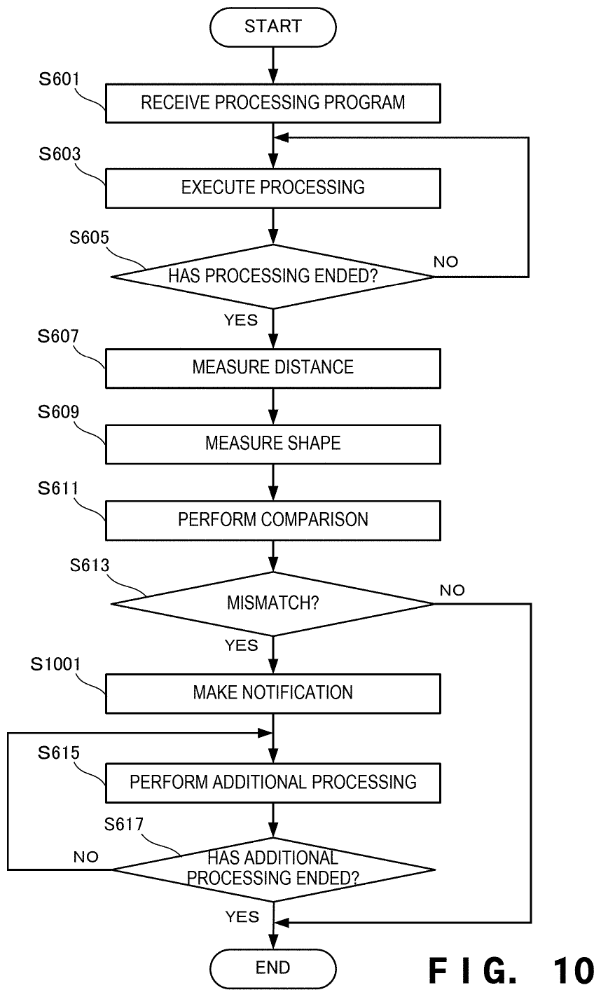

FIG. 10 is a flowchart for explaining the operation procedure of the laser processing apparatus according to this example embodiment. This flowchart is executed by the CPU 510 of FIG. 9 using the RAM 940, thereby implementing the functional components of the laser processing apparatus 700 shown in FIG. 7. In step S1001, the laser processing apparatus 700 notifies the operator or the like of the comparison result of the mismatch as an error. Note that the description has been provided using the flowchart of comparing the shapes with each other after completion of processing of the processing target object 211. However, the same applies to a case in which the shapes are compared with each other during processing of the processing target object 211.

According to this example embodiment, since a notification of the comparison result of the mismatch is made, the operator of the laser processing apparatus can readily know the mismatch. Furthermore, since the operator can readily know the comparison result of the mismatch, subsequent measures can quickly be taken.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

1. A laser processing apparatus comprising:
a light irradiator that irradiates a processing target object with a laser beam based on a processing model;
a measurer that measures a distance from said light irradiator to the processing target object based on reflected light of the laser beam from the processing target object; and
a processing controller that performs processing control based on the measured distance.

2. The apparatus according to claim 1, further comprising:
a shape measurer that measures a shape of the processing target object based on the measured distance; and
a comparator that compares the shape measured by said shape measurer with the processing model,
wherein said processing controller performs processing control in accordance with a comparison result obtained by said comparator.

3. The apparatus according to claim 2, further comprising a notifier that makes a notification of the comparison result obtained by said comparator.

4. The apparatus according to claim 1, wherein said measurer measures the distance during processing of the processing target object or after an end of the processing of the processing target object.

5. The apparatus according to, claim 1, wherein said light irradiator includes an electromechanical mirror.

6. A control method of a laser processing apparatus, comprising:
irradiating a processing target object with a laser beam based on a processing model;
measuring a distance from a light irradiator to the processing target object based on reflected light of the laser beam from the processing target object; and
performing processing control based on the measured distance.

7. A control program of a laser processing apparatus for causing a computer to execute a method, comprising:
irradiating a processing target object with a laser beam based on a processing model;
measuring a distance from a light irradiator to the processing target object based on reflected light of the laser beam from the processing target object; and
performing processing control based on the measured distance.
